(19) United States
(12) Patent Application Publication
(10) Pub. No.: US 2024/0147291 A1
(43) Pub. Date: May 2, 2024

(54) MULTI-LINK COMMUNICATIONS WITH VIRTUAL ACCESS POINTS IN MILLIMETER WAVE (MMWAVE) LINKS

(71) Applicant: NXP USA, Inc., Austin, TX (US)

(72) Inventors: Liwen Chu, San Ramon, CA (US); Kiseon Ryu, San Diego, CA (US); Hongyuan Zhang, Fremont, CA (US)

(21) Appl. No.: 18/385,328

(22) Filed: Oct. 30, 2023

Related U.S. Application Data
(60) Provisional application No. 63/381,387, filed on Oct. 28, 2022.

(51) Int. Cl. H04W 28/02; H04W 76/11

(52) U.S. Cl. CPC H04W 28/0215; H04W 76/11

(57) ABSTRACT

A method and apparatus for wireless communications are disclosed which includes transmitting a light mmWave link Beacon Frame from a first wireless device to a second wireless device through a mmWave link. The light mmWave Beacon Frame include a multiple BSSID element, that includes nontransmitted BSSID Profiles for virtual mmWave APs. A Beacon Frame is transmitted from the first wireless device to the second wireless device through a non-mmWave link. An association with a virtual mmWave AP of the first wireless device is established by the second wireless device through the non-mmWave link.

### CROSS-REFERENCE TO RELATED APPLICATIONS

This application is entitled to the benefit of U.S. Provisional Patent Application Ser. No. 63/381,387 filed on Oct. 28, 2022, which is incorporated by reference herein.

### BACKGROUND

In multi-link communications, an access point (AP) multi-link device (MLD) transmits various types of information using different transmission techniques to a non-AP MLD. For example, a wireless AP MLD wirelessly transmits data to one or more wireless stations in a non-AP MLD through one or more wireless communications links, such as a millimeter wave (mmWave) link. To facilitate the proper data transmission within a multi-link communications system having a mmWave link, a multi-link communications technology is used to efficiently convey communications signaling information, for example, information related to data, communications links, and/or multi-link devices (e.g., operation and/or capability parameters of multi-link devices) within the multi-link communications system.

To allow still further flexibility, an AP MLD is configured with one or more virtual APs. The virtual APs each support another network operating on the same physical hardware as the physical AP. Each virtual AP has a BSS (Basic Services Set), BSSID, and BSSID Profile. In order to accommodate the virtual APs without adding a new Beacon Frame for each virtual AP, a Multiple BSSID Element is used in the Beacon Frame. The Multiple BSSID Element has a first part for the physical AP, referred to as the transmitted BSSID or reference BSSID, and subelements for each of the virtual APs, referred to as the nontransmitted BSSID. The BSSID is transmitted or nontransmitted in terms of transmitting the Beacon Frame.

A STA parses the Multiple BSSID Element to determine the parameter set for each of the networks offered by the AP MLD. The STA may then select an AP and access the network of the selected virtual AP. An Association Request or any other exchange is used to access the selected virtual AP.

### SUMMARY

Embodiments of a method and apparatus for wireless communications are disclosed. In an embodiment, a method includes transmitting a light mmWave link Beacon Frame from a first wireless device to a second wireless device through a mmWave link, the light mmWave Beacon Frame including a multiple BSSID element, including nontransmitted BSSID Profiles for virtual mmWave APs, transmitting a Beacon Frame from the first wireless device to the second wireless device through a non-mmWave link, and establishing by the second wireless device an association with a virtual mmWave AP of the first wireless device through the non-mmWave link.

In an embodiment, the establishing the association comprises establishing a multi-link association for the mmWave link with the first wireless device.

In an embodiment, the multi-link association with the first wireless device comprises links of the mmWave link.

In an embodiment, the Beacon Frame includes simple information of the mmWave link.

In an embodiment, the simple information includes at least one of an operating channel, a critical update indication, and a target beacon transmission time.

In an embodiment, establishing an association comprises receiving an Association Response frame from the first wireless device in the non-mmWave link and wherein the Association Response frame includes a Max BSSID Indicator of a multiple BSSID set of the mmWave link.

In an embodiment, the Max BSSID Indicator is carried in a Per STA Profile of the Association Response frame.

In an embodiment, establishing an association comprises receiving an Association Response frame from the first wireless device in the non-mmWave link and wherein the Association Response frame includes a BSSID Index of a multiple BSSID set of the mmWave link.

In an embodiment, the BSSID Index is carried in an Ultra High Reliability operation element of a Per STA Profile of the Association Response frame.

In an embodiment, the virtual mmWave APs are co-hosted APs with the first wireless device, wherein establishing an association comprises receiving an Association Response frame from the first wireless device in the non-mmWave link, and wherein the Association Response frame includes a Max Co-Hosted BSSID Indicator of the co-hosted APs of the mmWave link

In an embodiment, the nontransmitted BSSID Profiles are reduced by removing a BSSID Capability field.

In an embodiment, the nontransmitted BSSID Profiles are reduced by removing a Robust Security Network information field.

An embodiment includes a wireless device having a processor, and a transceiver coupled to the processor. The transceiver is to transmit a light mmWave link Beacon Frame from the wireless device to a second wireless device through a mmWave link, the light mmWave Beacon Frame including a multiple BSSID element, including nontransmitted BSSID Profiles for virtual mmWave APs, transmit a Beacon Frame from the wireless device to the second wireless device through a non-mmWave link, and establish by the second wireless device an association with a virtual mmWave AP of the wireless device through the non-mmWave link.

In an embodiment, the establishing the association comprises establishing a multi-link association for the mmWave link with the wireless device.

In an embodiment, the multi-link association with the wireless device comprises links of the mmWave link.

In an embodiment, establishing an association comprises transmitting an Association Response frame from the wireless device in the non-mmWave link and wherein the Association Response frame includes a Max BSSID Indicator of a multiple BSSID set of the mmWave link.

In an embodiment, the virtual mmWave APs are co-hosted APs with the wireless device, wherein establishing an association comprises receiving an Association Response frame from the second wireless device in the non-mmWave link, and wherein the Association Response frame includes a Max Co-Hosted BSSID Indicator of the co-hosted APs of the mmWave link

In an embodiment, a method includes receiving a light mmWave link Beacon Frame from a second wireless device at a first wireless device through a mmWave link, the light mmWave Beacon Frame including a multiple BSSID element, including nontransmitted BSSID Profiles for virtual mmWave APs, receiving a Beacon Frame from the second wireless device at the first wireless device through a non-mmWave link, and establishing an association with a virtual mmWave AP of the second wireless device through the non-mmWave link.

In an embodiment, the establishing the association comprises establishing a multi-link association for the mmWave link with the second wireless device.

In an embodiment, establishing an association comprises receiving an Association Response frame from the second wireless device in the non-mmWave link and wherein the Association Response frame includes a Max BSSID Indicator of a multiple BSSID set of the mmWave link.

Throughout the description, similar reference numbers may be used to identify similar elements.

### BRIEF DESCRIPTION OF THE DRAWINGS

FIG. 1 depicts a multi-link communications system in accordance with an embodiment of the invention.

FIG. 2 depicts an example format of a frame body of a light mmWave Beacon Frame in accordance with an embodiment of the invention.

FIG. 3 depicts a nontransmitted BSSID Profile Subelement of a light mmWave Beacon Frame in accordance with an embodiment of the invention.

FIG. 4 depicts a nontransmitted BSSID Profile Subelement of a light mmWave Beacon Frame in accordance with an embodiment of the invention.

FIG. 5 depicts a reduced nontransmitted BSSID Profile Subelement of a light mmWave Beacon Frame in accordance with an embodiment of the invention.

FIG. 6 depicts a signaling diagram of forming an association with a virtual mmWave AP in accordance with an embodiment of the invention.

FIG. 7 depicts a wireless device in accordance with an embodiment of the invention.

FIG. 8 depicts a process flow diagram of forming an association with a virtual mmWave AP in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

In embodiments of a wireless communications system, a wireless device, e.g., an access point (AP) multi-link device (MLD) of a wireless local area network (WLAN) may transmit data to at least one associated wireless station (STA) MLD. The AP MLD may be configured to operate with associated STA MLDs according to a communication protocol. For example, the communication protocol may be an Institute of Electrical and Electronics Engineers (IEEE) 802.11 communication protocol.

As described in more detail below, virtual APs may also be used with mmWave systems. Multiple virtual mmWave APs may require some special provisions and features to be used in one AP device. First, the multiple virtual mmWave APs may be accommodated with an announcement of the corresponding multiple BSSID APs in a light mmWave Beacon Frame. Second, in order to keep to a low number of bits in the light mmWave Beacon Frame light, the full information corresponding to each of the multiple BSSID (Basic Service Set Identifier) APs available in the mmWave link may be provided in a non-mmWave link. A multi-link association with a virtual mmWave AP may also be made through the same non-mmWave link.

The light mmWave Beacon frame may be kept to fewer bits when including nontransmitted BSSID AP information by removing the elements that are not required after an association between a STA and a virtual mmWave AP. The other information may be exchanged in a non-mmWave link. As an example, a Max BSSID Indicator and a BSSID Index for the virtual mmWave APs may be placed in an Association Response message that is exchanged through the non-mmWave link. The Max BSSID Indicator indicates the number of active BSSIDs in the multiple BSSID AP Set. In one example, these indicators may be placed in a Per STA Profile of an Association Response for the respective virtual mmWave AP, for example in a UHR (Ultra High Reliability) Operation element

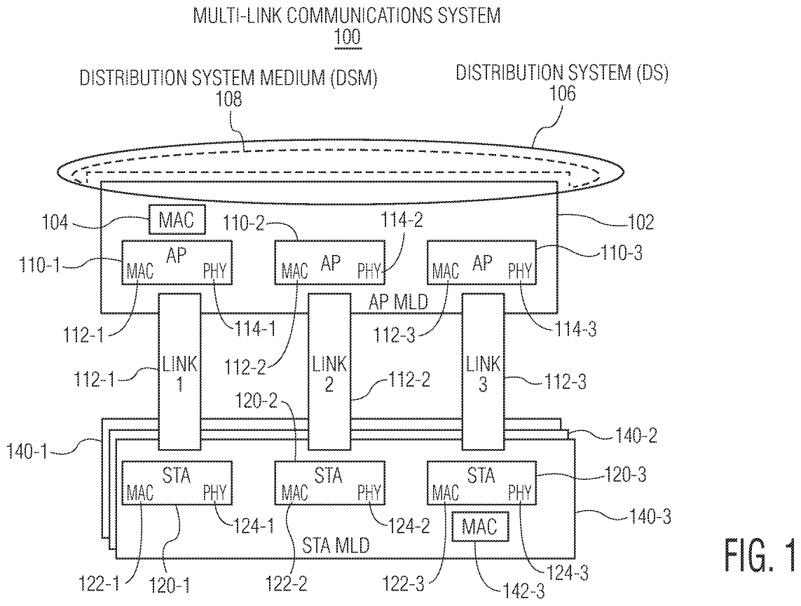

FIG. 1 depicts a multi-link (ML) communications system 100 in accordance with an embodiment of the invention. In the embodiment depicted in FIG. 1, the multi-link communications system includes at least one AP multi-link device (MLD) 102, and one or more non-AP multi-link devices, which are, for example, implemented as wireless station (STA) MLDs 140-1, 140-2, 140-3. The multi-link communications system can be used in various applications, such as industrial applications, medical applications, computer applications, and/or consumer or appliance applications. In some embodiments, the multi-link communications system is a wireless communications system, such as a wireless communications system compatible with an Institute of Electrical and Electronics Engineers (IEEE) 802.11 protocol.

Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 is shown in FIG. 1 includes the AP MLD 102 and the STA MLDs 140-1, 140-2, 140-3, in other embodiments, the multi-link communications system includes other multi-link devices, such as, multiple AP MLDs and multiple STA MLDs, multiple AP MLDs and a single STA MLD, a single AP MLD and a single STA MLD. In another example, in some embodiments, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities (e.g., beaconing, association establishment, reordering of frames, etc.) in an upper layer MAC device 104 and a link specific part of the AP MLD 102, i.e., the APs 110-1, 110-2, 110-3, implement lower layer MAC functionalities (e.g., backoff, frame transmission, frame reception, etc.) in lower layer MAC devices 122-1, 122-2, 122-3. The APs 110-1, 110-2, 110-3 may be implemented in hardware (e.g., circuits), software, firmware, or a combination thereof. At least one of the APs 110-1, 110-2, 110-3 may be fully or partially implemented as an integrated circuit (IC) device. In some embodiments, the AP MLD and its affiliated APs 110-1, 110-2, 110-3 are compatible with at least one wireless local area network (WLAN) communications protocol (e.g., at least one IEEE 802.11 protocol). For example, the APs 110-1, 110-2, 110-3 may be wireless APs compatible with at least one WLAN communications protocol (e.g., at least one IEEE 802.11 protocol).

In some embodiments, an AP MLD (e.g., the AP MLD 102) is connected to a local network (e.g., a local area network (LAN)) and/or to a backbone network (e.g., the Internet) through a wired connection and wirelessly connects to wireless STAs, for example, through one or more WLAN communications protocols, such as an IEEE 802.11 protocol. In some embodiments, an AP, e.g., the AP 110-1, the AP 110-2, and/or the AP 110-3, includes at least one antenna, at least one transceiver operably connected to the at least one antenna, and at least one controller operably connected to the corresponding transceiver. In some embodiments, at least one transceiver includes a physical layer (PHY) device 114-1, 114-2, 114-3 for each AP. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver.

In some embodiments, each of the APs 110-1, 110-2, 110-3 of the AP MLD 102 operates in different frequency bands. For example, at least one of the APs 110-1, 110-2, 110-3 of the AP MLD 102 operates in an Extremely High Frequency (EHF) band or the “millimeter wave (mmWave)” frequency band. In some embodiments, the mmWave frequency band is a frequency band between 20 Gigahertz (GHz) and 300 GHz. For example, the mmWave frequency band is a frequency band above 45 GHz, e.g., a 60 GHz frequency band. For example, the AP 110-1 may operate at 6 Gigahertz (GHz) band (e.g., in a 320 MHz (one million hertz) Basic Service Set (BSS) operating channel or other suitable BSS operating channel), the AP 110-2 may operate at 5 GHz band, e.g., a 160 MHz BSS operating channel or other suitable BSS operating channel, and the AP 110-3 may operate at 60 GHz band, e.g., a 160 MHz BSS operating channel or other suitable BSS operating channel.

In the embodiment depicted in FIG. 1, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium, e.g., Ethernet cables, telephone network cables, or fiber optic cables, or a wireless medium, e.g., infrared, broadcast radio, cellular radio, or microwaves. Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 140-3 includes radios, which are implemented as multiple non-AP stations (STAs) 120-1, 120-2, 120-3. The STAs 120-1, 120-2, 120-3 may be implemented in hardware (e.g., circuits), software, firmware, or a combination thereof. At least one of the STAs 120-1, 120-2, 120-3 may be fully or partially implemented as an IC device. In some embodiments, the non-AP STAs 120-1, 120-2, 120-3 are part of the STA MLD 140-3, such that the STA MLD may be a communications device that wirelessly connects to a wireless AP MLD, such as, the AP MLD 102. For example, the STA MLD 140-3 (e.g., at least one of the non-AP STAs 120-1, 120-2, 120-3) may be implemented in a laptop, a desktop personal computer (PC), a mobile phone, or other communications device that supports at least one WLAN communications protocol. In some embodiments, the STA MLD 140-3 and its affiliated STAs 120-1, 120-2, 120-3 are compatible with at least one IEEE 802.11 protocol.

In some embodiments, each of the non-AP STAs 120-1, 120-2, 120-3 includes at least one antenna, at least one transceiver operably connected to the at least one antenna, and at least one controller connected to the corresponding transceiver. In some embodiments, the at least one transceiver includes a PHY device 124-1, 124-2, 124-3. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver. In some embodiments, the STA MLD 140-3 has one MAC data service interface 142-3. In an embodiment, a single address is associated with the MAC data service interface 142-3 and is used to communicate on the DSM 108. In some embodiments, the STA MLD 140-3 implements a common MAC data service interface 142-3 and the non-AP STAs 120-1, 120-2, 120-3 implement a lower layer MAC data service interface 122-1, 122-2, 122-3.

In some embodiments, the AP MLD 102 and/or the STA MLDs 140-1, 140-2, 140-3 identify which communications links support the multi-link operation during a multi-link operation setup phase and/or exchanges information regarding multi-link capabilities during the multi-link operation setup phase. Each of the STAs 120-1, 120-2, 120-3 of the STA MLD may operate in a different frequency band. For example, at least one of the STAs 120-1, 120-2, 120-3 of the STA MLD 140-3 operates in the mmWave frequency band. In some embodiments, the mmWave frequency band is a frequency band between 20 GHz and 300 GHz. For example, the mmWave frequency band is a frequency band above 45 GHz, e.g., a 60 GHz frequency band. For example, the STA 120-1 may operate at 6 GHz band (e.g., in a 320 MHz BSS operating channel or other suitable BSS operating channel), the STA 120-2 may operate at 5 GHz band (e.g., a 160 MHz BSS operating channel or other suitable BSS operating channel), and the STA 120-3 may operate at 60 GHz band (e.g., a 160 MHz BSS operating channel or other suitable BSS operating channel). Although the STA MLD 140-3 is shown in FIG. 1 as including three non-AP STAs, other embodiments of the STA MLD 140-3 may include fewer than three non-AP STAs or more than three non-AP STAs.

Each of the STA MLDs 140-1, 140-2 may be the same as or similar to the STA MLD 140-3. For example, the STA MLD 140-1 or 140-2 includes multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver.

In the embodiment depicted in FIG. 1, the STA MLD 140-3 communicates with the AP MLD 102 through multiple communications links 112-1, 112-2, 112-3. For example, each of the STAs 120-1, 120-2, 120-3 communicates with an AP 110-1, 110-2, or 110-3 through a corresponding communications link 112-1, 112-2, or 112-3. Although the AP MLD 102 communicates (e.g., wirelessly communicates) with the STA MLD 140-3 through multiple links 112-1, 112-2, 112-3, in other embodiments, the AP MLD 102 may communicate (e.g., wirelessly communicate) with the STA MLD through more than three communications links or less three than communications links. In the embodiment depicted in FIG. 1, the communications links 112-1, 112-2, 112-3 between the AP MLD and the STA MLD 140-3 involve at least one mmWave link. For example, the communications links 112-1, 112-2, 112-3 between the AP MLD 102 and the STA MLD 140-3 include a mmWave link (e.g., a 45/60 GHz link) between an AP of the AP MLD 102 and a STA of the STA MLD 140-3 operating in a mmWave frequency band (e.g., a 45/60 GHz frequency band) and two non-mmWave links (e.g., 2.4 GHz, 5 GHz, or 6 GHz links) and two mmWave links (e.g., a 45 GHz link and a 60 GHz link) between APs of the AP MLD 102 and STAs of the STA MLD 140-3 operating in non-mmWave frequency bands (e.g., 2.4 GHz, 5 GHz, or 6 GHz frequency bands).

In another example, the communications links 112-1, 112-2, 112-3 between the AP MLD 102 and the STA MLD 140-3 include two mmWave links (e.g., 45/60 GHz links) between APs of the AP MLD 102 and STAs of the STA MLD 140-3 operating in mmWave frequency bands (e.g., 45/60 GHz frequency bands) and one non-mmWave link (e.g., a 2.4 GHz, 5 GHz, or 6 GHz link) between an AP of the AP MLD 102 and an STA of the STA MLD 140-3 operating in a non-mmWave frequency bands (e.g., a 2.4 GHz, 5 GHz, or 6 GHz frequency band). The control and management of a mmWave link, for example, a GHz/60 GHz link may be performed in a non-mmWave link, for example, a 2.4 GHz, 5 GHz, or 6 GHz link. For example, the association of a non-AP MLD with a mmWave link can be done through a non-mmWave MHz link. However, beaconing and channel switch can be challenging for a MLD system with one or more mmWave links.

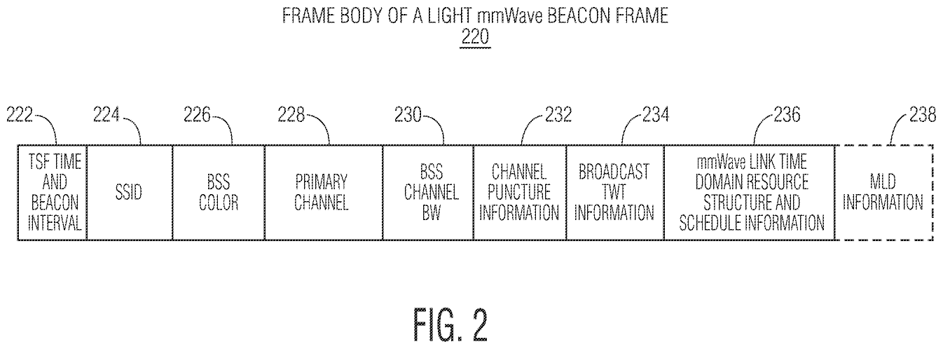

FIG. 2 depicts an example format of the frame body in a light mmWave Beacon Frame 220 (the MAC header, Frame Check Sequence (FCS) of the light Beacon Frame are not shown) in accordance with an embodiment of the invention. In some embodiments, a light mmWave Beacon Frame 220 is used. The full information of a mmWave link can be announced in a non-mmWave link, for example a 2.4/5/6 GHz link. In some embodiments, if the minimal channel in a mmWave link is 160 MHz, the primary channel information 228 is updated accordingly.

In the embodiment depicted in FIG. 2, the frame body of the light mmWave Beacon Frame 220 includes a field containing a TSF (Timing Synchronization Function) time and beacon interval 222, an element containing SSID 224 or short SSID, a field containing the BSS color 226 of a corresponding BSS (e.g., a BSS with which a mmWave AP is affiliated), a field containing the primary channel information 228, a field containing the bandwidth (BW) of the BSS operating channel 230, an optional field containing the channel puncture information 232, an optional field containing broadcast TWT (Target Wake Time) information 234, a field containing mmWave link time domain resource structure and schedule information 236, and an optional field 238 containing the AP MLD information with which a mmWave AP is affiliated.

Although the fields of the light mmWave Beacon Frame 220 are shown in FIG. 2 in a certain order, other embodiments of the light mmWave Beacon Frame may include the same, fewer, or more fields in a different order. In one embodiment, a Control field may be required to carry the information about whether each optional field is carried or not. In addition, although the frame body of the light mmWave Beacon Frame 220 is shown in FIG. 2 with certain fields, other embodiments of the light mmWave Beacon Frame may include fewer or more fields to carry the same, less, or more information. A mmWave link 112-1, (e.g., a 45 GHz link or a 60 GHz link) between an AP MLD 102 and a non-AP STA MLD 140-3 can be used to transmit a light mmWave Beacon Frame 220. In one embodiment, a full mmWave Beacon Frame is not defined. In another embodiment, a full mmWave Beacon Frame may also be defined and used to suit particular circumstances. The full mmWave Beacon Frame contains more fields including RNR (Reduced Neighbor Report) information and a Basic Multi-Link element.

In a multiple BSSID (Basic Service Set Identifier) AP set, the transmitted BSSID AP, i.e., the AP that is transmitting the Beacon Frame, also referred to as the reference AP, transmits its own BSSID and BSSID Parameter Set and also transmits a multiple BSSID element in the same Beacon Frame. This approach is used in 2.4 GHz, 5 GHz, and 6 GHZ bands. The multiple BSSID element has subelements for the nontransmitted BSSID APs. The reference AP also transmits control frames to STAs that are associated with any of the virtual APs in the multiple BSSID AP set. This permits MU frame exchanges and other types of control and data transactions.

The APs of a multiple BSSID AP set have the same BSS Color so that the same spectrum is not used simultaneously by different ones of the virtual APs absent other spatial or modulation techniques to avoid interference. A STA associated with the first one of the APs, whether the reference AP or a virtual AP listens to the allocated spectrum, e.g., performs a CCA (Clear Channel Assessment) to ensure that the allocated spectrum is clear before transmitting and does not transmit its data if the channel is not clear.

In HE (High Efficiency) modes virtual APs may be supported as a co-hosted BSSID set. An HE Operation element can announce a co-hosted BSSID set. Each BSSID in the set corresponds to a virtual AP, where all the APs in the set share the same antenna connector, the same BSS operating channel, and the same color. However, a 6 GHz HE AP collocated with other virtual APs in the same device cannot announce the support of a co-hosted BSSID set. Instead, it is to use the Multiple BSSID set described above. For the co-hosted BSSID set, each AP transmits its own Beacon Frame which increases the resources that are used for Beacon Frames instead of for frame exchanges.

Collisions with frame exchanges associated with other virtual APs using the same BSS operating channel are avoided in the same way described above, e.g., using CCA, or other techniques.

For mmWave links, a light mmWave Beacon Frame is transmitted for the sake of coexisting with neighboring BSS operating channels, inter alia. The light mmWave Beacon Frame does not contain all of the information of a Beacon Frame as may be used in other contexts. This information, the full information of the mmWave link, is announced in a 2.4 GHz, 5 GHz, or 6 GHz link. These are referred to as the non-mmWave links. The full information of the mmWave link can be announced in the mmWave link as a Beacon Frame or other announcement. However, there may be many STA MLDs, e.g., non-AP MLDs, that have a mmWave link but do not decode the Beacon Frame that is transmitted in the mmWave link.

There are some STAs and STA MLDs that do not receive mmWave Beacon Frames because doing so consumes more power than Beacon Frames on other bands. The same STAs and STA MLDs, e.g., non-AP MLDs, still receive the broadcast frames through the other bands, e.g., non-mmWave links.

An AP device that includes multiple AP MLDs with mmWave links may use a multiple BSSID in the mmWave link and provide association through a non-mmWave link. The AP device has virtual APs that share the same antenna connector, BSS color, and BSS operating channel.

Multiple BSSID in a mmWave Link

A light mmWave Beacon Frame 220, as shown in FIG. 2, may be transmitted by an AP of a multiple BSSID AP set. The light mmWave Beacon Frame 220 includes the elements of the transmitted BSSID AP, e.g., the SSID 224, the BSS color 226, the primary channel 228, etc. The light mmWave Beacon Frame 220 may also carry a multiple BSSID element, e.g., in the MLD information 238. The multiple BSSID element may include all of the information of the nontransmitted BSSID APs as one or more Nontransmitted BSSID Profile subelements.

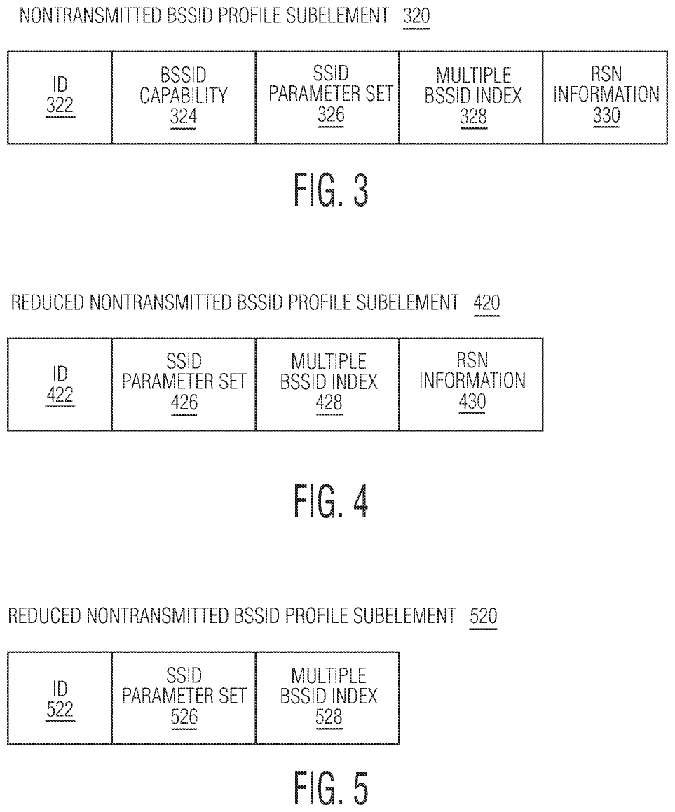

FIG. 3 depicts an example Nontransmitted BSSID Profile subelement 320 as may be applied to the MLD information 238. There may be a Nontransmitted BSSID Profile Subelement for each virtual mmWave AP. It includes a Subelement ID 322, a BSSID Capability field 324, an SSID Parameter Set field 326, a Multiple BSSID Index filed 328, and an RSN (Robust Security Network) information field 330. The BSSID Index field may include an element ID, length, Index, DTIM (Delivery Traffic Indication Message) Period and DTIM Count. Similarly each other field may include multiple separate parameters and subfields. When there are multiple virtual mmWave APs, then the additional subelements for each one, may significantly add to the size of the light mmWave Beacon Frame. This reduces the BW available for carrying payloads in frame exchanges.

FIG. 4 depicts an example reduced Nontransmitted BSSID Profile subelement 420 in which the BSSID Capability field 324 has been removed. This reduces the BW required for each subelement in the light mmWave Beacon Frame. The Nontransmitted BSSID Profile subelement 420 still includes a Subelement ID 422, a SSID parameter Set 426, a Multiple BSSID Index 428, and RSN Information 430. The multiple BSSID element may be redefined for use in a light mmWave Beacon Frame by removing some of the elements that are less important or that may be available in a non-mmWave Beacon Frame.

The important elements may include:
the SSID, and
the Multiple BSSID Index.

The less important elements that may be removed may include:
the BSSID Capability;
the RSN Information;
other UHR elements of a specific nontransmitted BSSID AP; and
non-inheritance elements.

FIG. 5 depicts an example reduced Nontransmitted BSSID Profile subelement 520 in which the BSSID Capability field 324 and the RSN Information 330 have been removed. This further reduces the BW required for each subelement in the light mmWave Beacon Frame. The Nontransmitted BSSID Profile subelement 520 still includes a Subelement ID 522, a SSID parameter Set 526, and a Multiple BSSID Index 528. The multiple BSSID element may be redefined for use in a light mmWave Beacon Frame by removing only the RSN Information 330 and retaining the BSSID Capability field 324 and in other ways to remove some of the elements that are less important for the light mmWave Beacon Frame. Additional elements and subelements, not mentioned herein, may be determined as more or less important and may be removed from the light mmWave Beacon Frame.

Association Through Non-mmWave Link

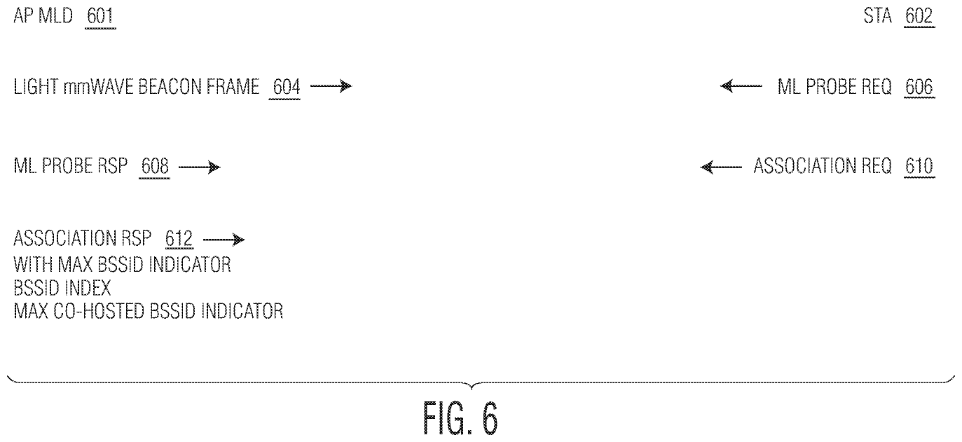

Removing less important information from the light mmWave Beacon Frame, means that this information must be broadcast or otherwise transmitted from an AP MLD in another way. FIG. 6 depicts a frame exchange for association between an AP MLD 601 and a STA 602. In some circumstances, a STA 602 obtains an association with a mmWave AP, including a virtual AP by first receiving the light mmWave Beacon Frame 604 from an AP MLD 601 to identify a mmWave AP, selecting one of the APs announced in the light mmWave Beacon Frame 604 and then transmitting a Multi-Link Probe Request 606 for the mmWave AP over a non-mmWave link. The AP MLD then sends a Multi-Link Probe Response 608 to the STA 602 which allows a frame exchange to occur for association, e.g., an Association Request Frame 610 and an Association Response Frame 612.

Through this process, it may not be practical or feasible to add all of the information about the requested AP to the beacons, the ML Probe Response, etc. The beacons and the Multi-Link Probe Response in the non-mmWave links may not be able to carry enough Multiple BSSID information about the APs that support mmWave links to make mmWave frame exchanges possible. A multi-link association with mmWave link may not have sufficient information about a particular nontransmitted AP. For a mmWave AP that has a nontransmitted BSSID, the Per STA Profile of the mmWave AP will not carry any information of the Multiple BSSID set that includes the mmWave AP.

The Association Response frame may be used to provide this information to the STA that is probing the nontransmitted mmWave AP with a ML Probe Request. The Per STA Profile of each mmWave AP may be supplemented to include the Max BSSID Indicator of a multiple BSSID set of a mmWave link. In addition the BSSID Index of the mmWave AP may also be carried in each mmWave AP's Per STA Profile of the Multi-Link element of the Association Response frame. This provides the Max BSSID Indicator and the BSSID Index of the mmWave AP to the STA during the association frame exchange by using the Association Response frame. FIG. 6 depicts the Association Response frame 612 transmitted from the AP MLD 601 to the STA 602 and including the Max BSSID Indicator and the BSSID Index.

As stated, the association frame exchange may be augmented to convey the Max BSSID Indicator and the BSSID Index allowing for an association between a STA and a virtual AP with a nontransmitted BSSID profile or a reduced nontransmitted BSSID profile as described above. The Max BSSID Indicator of a multiple BSSID set of a mmWave link is carried in a Per STA Profile in the Association Response frame of each mmWave AP. The BSSID Index of the mmWave AP of the Max BSSID Indicator of multiple BSSID set of the mmWave link is also carried in the Per STA Profile in the Association Response frame of each mmWave AP.

Co-Hosted APs in a mmWave Link

The use of the Per STA Profile may be expanded to also apply to co-hosted APs of an MLD AP in a mmWave link. While for co-hosted APs, the light mmWave Beacon Frame of each mmWave AP includes Max Co-hosted BSSID Indicator. However, this element may not be available when a STA tries to make an association with a co-hosted AP using a non-mmWave link. To provide this relevant and timely information, the Max Co-hosted BSSID Indicator of a mmWave link may be carried in the Association Response frame in the non-mmWave link. In particular it may be carried in the UHR Operation element of each mmWave AP's BSS Per STA Profile. FIG. 6 depicts the Association Response frame 612 transmitted from the AP MLD 601 to the STA 602 and including the Max Co-Hosted BSSID Indicator.

Methods have been presented that facilitate supporting a multiple BSSID feature in the mmWave link between a first wireless device with multiple links, e.g., an AP MLD, and a second device with multiple links, e.g., a STA. The method includes transmitting the light mmWave Beacon Frame in a mmWave link. This is transmitted by the AP MLD and received by the STA. The light Beacon in mmWave link includes the elements of the transmitted BSSID AP and Multiple BSSID element to carry the information of the non-transmitted BSSID APs.

In a different link, not a mmWave link, the AP (AP1) transmits a Beacon Frame with simple information about the APs affiliated with the same AP MLD as AP1 or affiliated with the same AP MLD as the nontransmitted BSSID AP that is in the same multiple BSSID set. The simple information may include the following information of the mmWave AP: the operating channel, critical update indication, the indication of whether critical update is carried in this Beacon, optional TBTT (Target Beacon Transmission Time) of the mmWave Beacon.

After receiving these beacon frames, a STA is able to begin establishing a multi-link association with a virtual mmWave AP of the AP MLD. using the different link, not the mmWave link. The association links are mmWave links.

In some circumstances, the AP MLD may use the association frame exchange to convey additional information about the virtual mmWave AP or even a co-hosted mmWave AP. In some examples, the Association Response frame of the frame exchange which is sent in a link other than the mmWave link includes the Max BSSID Indicator of a multiple BSSID set of the mmWave link.

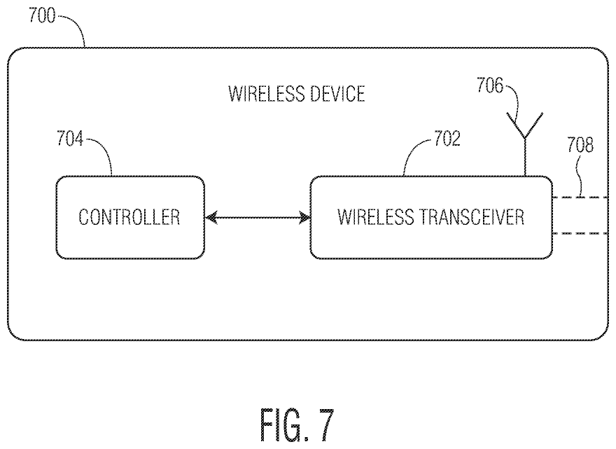

FIG. 7 depicts a wireless device 700 in accordance with an embodiment of the invention. The wireless device 700 can be used in the multi-link communications system 100 depicted in FIG. 1. For example, the wireless device 700 may be an embodiment of the APs 110-1, 110-2, 110-3 and/or the STAs 120-1, 120-2, 120-3 depicted in FIG. 1. However, the APs 110-1, 110-2, 110-3 and the STAs 120-1, 120-2, 120-3 depicted in FIG. 1 are not limited to the embodiment depicted in FIG. 7. In the embodiment depicted in FIG. 7, the wireless device 700 includes a wireless transceiver 702, a controller 704 operably connected to the wireless transceiver, and at least one antenna 706 operably connected to the wireless transceiver. In some embodiments, the wireless device 700 may include at least one optional network port 708 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol).

In some embodiments, the wireless device 700 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port. The wireless device 700 may be compatible with an IEEE 802.11 protocol.

In accordance with an embodiment of the invention, the controller 704 is configured to generate a millimeter wave (mmWave) Beacon Frame and the wireless transceiver 702 is configured to transmit the mmWave Beacon Frame to a second wireless MLD through a mmWave link between a wireless MLD to which the wireless device 700 belongs and the second wireless MLD. In some embodiments, the wireless MLD includes an access point (AP) MLD that includes a wireless AP, and the wireless AP includes the controller and the wireless transceiver. In some embodiments, the second wireless MLD includes a non-AP MLD that includes a non-AP station (STA). In some embodiments, the controller is further configured to generate full mmWave link information of the mmWave link. In some embodiments, the wireless transceiver is further configured to transmit the full mmWave link information of the mmWave link to the second wireless MLD through a non-mmWave link between the wireless MLD and the second wireless MLD. In some embodiments, the non-mmWave link includes one of a 2.4 Gigahertz (GHz) link, a 5 GHz link, or a 6 GHz link.

In some embodiments, the wireless transceiver is further configured to transmit the full mmWave link information of the mmWave link to the second wireless MLD through the mmWave link. In some embodiments, the mmWave link includes a 45 GHz link or a 60 GHz link. In some embodiments, the controller is further configured to generate a second mmWave Beacon Frame or a beacon extension that contains the full mmWave link information of the mmWave link. In some embodiments, the wireless MLD device is compatible with an Institute of Electrical and Electronics Engineers (IEEE) 802.11 protocol. In some embodiments, the controller is further configured to generate a broadcast frame that contains control or management information of the mmWave link, and wherein the wireless transceiver is further configured to transmit the broadcast frame through a non-mmWave link.

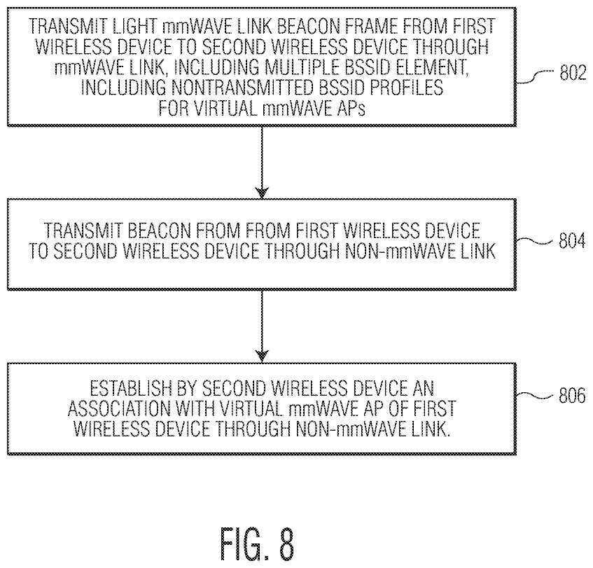

FIG. 8 depicts a process flow diagram of establishing an association between a STA and a virtual mmWave AP. The method begins by performing, at 802, transmitting a light mmWave link Beacon Frame from a first wireless device to a second wireless device through a mmWave link. The light mmWave Beacon Frame includes a multiple BSSID element that includes nontransmitted BSSID Profiles for virtual mmWave APs.

At 804, transmitting a Beacon Frame from the first wireless device to the second wireless device through a non-mmWave link is performed. At 806 the second wireless device establishes an association with a virtual mmWave AP of the first wireless device through the non-mmWave link.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer-readable storage medium for execution by a computer. As an example, an embodiment of a computer program product includes a computer-readable storage medium to store a computer readable program.

The computer-readable or computer-useable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method comprising:
transmitting a light mmWave link Beacon Frame from a first wireless device to a second wireless device through a mmWave link, the light mmWave Beacon Frame including a multiple BSSID element, including nontransmitted BSSID Profiles for virtual mmWave APs;
transmitting a Beacon Frame from the first wireless device to the second wireless device through a non-mmWave link; and
establishing by the second wireless device an association with a virtual mmWave AP of the first wireless device through the non-mmWave link.

2. The method of claim 1, wherein the establishing the association comprises establishing a multi-link association for the mmWave link with the first wireless device.

3. The method of claim 2, wherein the multi-link association with the first wireless device comprises links of the mmWave link.

4. The method of claim 1, wherein the Beacon Frame includes simple information of the mmWave link.

5. The method of claim 1, wherein the simple information includes at least one of an operating channel, a critical update indication, and a target beacon transmission time.

6. The method of claim 1, wherein establishing an association comprises receiving an Association Response frame from the first wireless device in the non-mmWave link and wherein the Association Response frame includes a Max BSSID Indicator of a multiple BSSID set of the mmWave link.

7. The method of claim 6, wherein the Max BSSID Indicator is carried in a Per STA Profile of the Association Response frame.

8. The method of claim 1, wherein establishing an association comprises receiving an Association Response frame from the first wireless device in the non-mmWave link and wherein the Association Response frame includes a BSSID Index of a multiple BSSID set of the mmWave link.

9. The method of claim 8, wherein the BSSID Index is carried in an Ultra High Reliability operation element of a Per STA Profile of the Association Response frame.

10. The method of claim 1, wherein the virtual mmWave APs are co-hosted APs with the first wireless device, wherein establishing an association comprises receiving an Association Response frame from the first wireless device in the non-mmWave link, and wherein the Association Response frame includes a Max Co-Hosted BSSID Indicator of the co-hosted APs of the mmWave link

11. The method of claim 1, wherein the nontransmitted BSSID Profiles are reduced by removing a BSSID Capability field.

12. The method of claim 1, wherein the nontransmitted BSSID Profiles are reduced by removing a Robust Security Network information field.

13. A wireless device comprising:
a processor; and
a transceiver coupled to the processor, the transceiver to:
transmit a light mmWave link Beacon Frame from the wireless device to a second wireless device through a mmWave link, the light mmWave Beacon Frame including a multiple BSSID element, including nontransmitted BSSID Profiles for virtual mmWave APs;
transmit a Beacon Frame from the wireless device to the second wireless device through a non-mmWave link; and
establish by the second wireless device an association with a virtual mmWave AP of the wireless device through the non-mmWave link.

14. The method of claim 13, wherein the establishing the association comprises establishing a multi-link association for the mmWave link with the wireless device.

15. The method of claim 14, wherein the multi-link association with the wireless device comprises links of the mmWave link.

16. The method of claim 13, wherein establishing an association comprises transmitting an Association Response frame from the wireless device in the non-mmWave link and wherein the Association Response frame includes a Max BSSID Indicator of a multiple BSSID set of the mmWave link.

17. The method of claim 13, wherein the virtual mmWave APs are co-hosted APs with the wireless device, wherein establishing an association comprises receiving an Association Response frame from the second wireless device in the non-mmWave link, and wherein the Association Response frame includes a Max Co-Hosted BSSID Indicator of the co-hosted APs of the mmWave link

18. A method comprising:
receiving a light mmWave link Beacon Frame from a second wireless device at a first wireless device through a mmWave link, the light mmWave Beacon Frame including a multiple BSSID element, including nontransmitted BSSID Profiles for virtual mmWave APs;
receiving a Beacon Frame from the second wireless device at the first wireless device through a non-mmWave link; and
establishing an association with a virtual mmWave AP of the second wireless device through the non-mmWave link.

19. The method of claim 18, wherein the establishing the association comprises establishing a multi-link association for the mmWave link with the second wireless device.

20. The method of claim 1, wherein establishing an association comprises receiving an Association Response frame from the second wireless device in the non-mmWave link and wherein the Association Response frame includes a Max BSSID Indicator of a multiple BSSID set of the mmWave link.
